(19) United States
(12) Patent Application Publication
(10) Pub. No.: US 2017/0124488 A1
(43) Pub. Date: May 4, 2017

(54) Coordination of provision of a service

(71) Applicant: Bernd Hartmann, Grafschaft-Leimersdorf (DE)

(72) Inventor: Bernd Hartmann, Grafschaft-Leimersdorf (DE)

(73) Assignee: Deutsche Post AG, Bonn (DE)

(21) Appl. No.: 15/287,491

(22) Filed: Oct. 6, 2016

(30) Foreign Application Priority Data
Oct. 30, 2015 (EP) 15192353.9

(51) Int. Cl. G06Q 10/02; G05B 15/02; H04L 29/08

(52) U.S. Cl. CPC G06Q 10/02; H04L 67/12; H04L 67/327; G05B 15/02

(57) ABSTRACT

In a group of apparatuses, each apparatus is associated with a particular unit. A first apparatus of the group receives information regarding a service to be provided and transmits a message regarding the service to a plurality of other apparatuses of the group. The first apparatus determines, on the basis of rules, whether the service to be provided can be provided by a unit or by a combination of units. The determination can be based on the information regarding the service to be provided and on information pertaining to the current performance capability of the units. The latter can be determined by the first apparatus on the basis of stored information and feedback from the other apparatuses. If the service can be provided, then the first apparatus books capacities on the apparatus with which the unit that can provide the service is associated.

### CROSS-REFERENCE TO RELATED PATENT APPLICATION

This patent application claims priority to European Application No. 15192353.9, filed Oct. 30, 2015, the entire teachings and disclosure of which are incorporated herein by reference thereto.

### FIELD OF THE INVENTION

The present invention relates to coordination of the provision of a service, but particularly not exclusively of a service in logistics.

### BACKGROUND TO THE INVENTION

Services in logistics can comprise collection, carriage and/or delivery of piece goods, for example.

Services in logistics can likewise comprise sorting of piece goods by a conveying and sorting installation, for example.

Conventionally, requested services are captured in a central server. The server then creates an optimized carriage route and causes a carriage unit or multiple carriage units to perform carriage as appropriate.

### GENERAL DESCRIPTION OF SOME EXEMPLARY EMBODIMENTS OF THE INVENTION

One of the objects of the invention is to allow the particularly efficient provision of a service.

The invention is defined by the appended claims.

An exemplary embodiment of a method according to the invention is performed by a first apparatus of a group of apparatuses, each apparatus of the group being associated with a particular unit. The method comprises receiving information regarding a service to be provided. The method further comprises transmitting a message to a plurality of other apparatuses of the group regarding the service to be provided, on the basis of the received information. The method further comprises determining, on the basis of rules, whether the service to be provided can be provided at least in part by a unit that has an associated apparatus of the group or by a combination of units that each have an associated apparatus of the group, on the basis of the information regarding the service to be provided, on the basis of stored information pertaining to the current performance capability of a first unit with which the first apparatus is associated, and on the basis of feedback from other apparatuses of the group pertaining to the current performance capability of other units with which the apparatuses that provide the feedback are associated. If it is determined that the service to be provided can be provided at least in part by a unit that has an associated apparatus of the group or by a combination of units that each have an associated apparatus of the group, then the method further comprises booking capacities on the at least one apparatus of the group that is associated with the at least one unit that can provide the service to be provided at least in part.

An exemplary embodiment of an apparatus according to the invention comprises means for causing the apparatus to perform an arbitrary embodiment of the method according to the invention. The means can comprise at least one memory having program instructions and at least one processor, for example. The at least one processor may be configured to execute program instructions from the at least one memory. The program instructions may be configured to cause the apparatus to perform an arbitrary embodiment of the method according to the invention when they are executed by the at least one processor. The memory may be a volatile or nonvolatile memory. The memory may be removable or firmly integrated in the apparatus. The apparatus can comprise arbitrary further components. It goes without saying that the means may alternatively, at least in part, also be implemented in circuitry.

An exemplary embodiment of a system according to the invention comprises an arbitrary embodiment of an apparatus according to the invention and furthermore further apparatuses of the group of apparatuses. The system can comprise arbitrary further elements, for example a server and/or apparatuses from other groups of apparatuses.

An exemplary embodiment of a computer program according to the invention comprises program instructions that are configured to cause an apparatus to perform an arbitrary embodiment of the method according to the invention when they are executed by at least one processor.

The computer program may be stored in a substantive computer-readable medium, for example in a volatile or nonvolatile program memory of an apparatus or on a memory chip or memory stick. It can alternatively be transmitted via the internet and/or via wired lines.

The invention is based on the consideration that central control of services to be provided has only limited suitability for fully depicting real circumstances.

For exemplary embodiments, the invention therefore provides for service-providing units each to have an associated apparatus. The apparatuses coordinate the provision of services by the units among one another in order to be able to coordinate the behavior of the devices autonomously. A service to be provided is respectively coordinated in a group of apparatuses. This involves consideration firstly of information pertaining to the service to be provided and secondly of the current opportunities for use of the units.

This allows better scheduling of the provision of a service such that it can be effected economically, quickly and reliably with regard to particular requirements. If it is a service that is requested specifically by a customer, then this also allows the satisfaction of the customer to be ensured in a better manner. Similarly, efficient use of natural resources can be supported.

The group can comprise all apparatuses associated with a respective service-providing unit that belong to a system, or just some of the apparatuses. If a group comprises a portion of all apparatuses, then this portion may be firmly or variably associated with the group. If there are multiple groups provided for a system, then the association can be made regularly, for example, at particular intervals, such as daily, weekly or monthly. Additionally, it is optionally also possible for unscheduled changes to the group to be made possible. The respective unit that has an associated apparatus can also be considered part of the group.

A group can also be regarded as a cluster or partial cluster and the apparatuses can be regarded as individuals in the cluster or in the partial cluster that, with their cluster behavior, are able to contribute to coordinating and optimizing the provision of services.

In one exemplary embodiment, a unit that has an associated apparatus of the group is a person who can optionally use a vehicle. Such a person may be a delivery agent or another person tasked with the carriage of piece goods, for example. The apparatus can assist the person in the carriage of piece goods and in the tracking of actions that have taken place, for example. If the unit is a person, then he could alternatively also be operating personnel for a production machine, for example. The apparatus may then be integrated in the production machine, for example, and provide the person with information pertaining to respectively imminent production steps. In other exemplary embodiments, a unit that has an associated apparatus of the group is a component of a sorting installation or a component of a production installation. The apparatus can actuate such a component directly, for example. In other exemplary embodiments, a unit that has an associated apparatus of the group is an agent responsible for maintenance of a system—if need be together with other agents. By way of example, the apparatus may be part of such an agent and actuate it directly. As a further alternative, a unit may be any unit that can contribute to services for which the contribution by multiple units possibly needs to be coordinated.

The information regarding a service to be provided can reach the first apparatus in one or more ways. As such, it may involve a user input using a user interface that the first apparatus comprises or that is connected to said first apparatus, for example. Alternatively or additionally, information regarding a service to be provided can be captured by means of a scan; the first apparatus may comprise a corresponding scanner component or be connected to a scanner component. Alternatively or additionally, information regarding a service to be provided can be captured by means of a photograph; the first apparatus may comprise a corresponding camera component or be connected to a camera component. Alternatively or additionally, information regarding a service to be provided can be received via a radio interface. By way of example, the radio interface can allow a direct connection to a device or a tag over a short distance, or an indirect connection via a wireless local area network or a mobile radio. In the latter case, the information can be provided and transmitted by a server or by another apparatus outside the group, for example.

By way of example, the communication between the apparatuses of a group can be effected wirelessly, for example via mobile radio, if the apparatuses are provided for mobile use, or for example via a WLAN, if the apparatuses are mounted in a fixed manner or are provided for mobile use within a restricted site. By way of example, the communication between the apparatuses can also be effected by wire, for example via a wired local communication network, if the apparatuses are mounted in a fixed manner.

The feedback from other apparatuses of the group pertaining to the current performance capability of units with which the apparatuses are associated may be of different type. They can comprise stored information that the respective apparatus merely retrieves and transmits to the first apparatus. They may alternatively already comprise a first evaluation of such stored information.

In one exemplary embodiment, the feedback from other apparatuses of the group pertaining to the current performance capability of units with which the apparatuses that provide the feedback are associated comprises an indication of a possible contribution by the units to the provision of the service to be provided. This has the advantage that the computation complexity on the first apparatus can be kept lower. An indication of a possible contribution can define a single possible and specific contribution or it can define a plurality of possible contributions or it can define at least one contribution with acceptable leeways for at least one criterion. By way of example, a particular contribution could be provided not just for a particular time but rather for an arbitrary time in a defined period.

In one exemplary embodiment, the information pertaining to the current performance capability of the first unit and/or the feedback pertaining to the current performance capability of further units comprises information pertaining to the respective unit. Examples include information pertaining to a predetermined responsibility of the respective unit and/or information pertaining to a total capacity of the respective unit and/or information pertaining to a free capacity of the respective unit and/or information pertaining to a type of the respective unit and/or information pertaining to a type of equipment used by the respective unit and/or information pertaining to a possible performance speed of the respective unit and/or information pertaining to services to be performed that are already scheduled for the respective unit and/or information pertaining to specifications for already scheduled services to be performed by the respective unit and/or information pertaining to a status of services to be performed by the respective unit and/or information pertaining to a current position of the respective unit and/or information pertaining to current obstacles that affect the respective unit and/or information pertaining to an availability of the respective unit and/or information pertaining to an operating state of the respective unit and/or information pertaining to an operating state of equipment used by the respective unit.

Information pertaining to a total or free capacity of a unit can comprise indications of a volume-related, quantity-related, weight-related and/or temporal capacity, for example. If the unit is a person, then the information may particularly also relate to the capacity of a vehicle used by the person for providing services or partial services or of a production machine used by the person for providing services or partial services. If the unit is a conveyor belt in a sorting installation, then the capacity may also comprise an available width of the conveyor belt, for example. Services to be performed that are already scheduled for the unit and/or specifications for already scheduled services to be performed by the unit can comprise, inter alia, a sequence of actions that is predetermined for at least one instance of a provision of a service. The sequence of actions can define flows on a temporal and/or geographical basis. Specifications for already scheduled services to be performed by the respective unit can comprise associated priorities, which can indicate which services are to be performed first and/or with invariable timings, for example. A type of a unit can distinguish between a delivery agent with a handcart, a bicycle, a motorcycle or a van, or between a filter, a sorter and a conveying unit in a sorting installation, or between different kinds of production machines in a production installation, for example. A possible performance speed may be the average speed of a delivery agent on foot, by bicycle in cities, by van in cities or cross country, or a maximum belt speed in a conveying unit or the duration of a particular production step, for example. A current position of a unit may relate particularly to mobile units. A current position of a unit may be indicated in absolute or relative terms, for example relative to a base. An obstacle affecting a unit may be a queue, for example, if the unit is a delivery agent with a delivery vehicle, or it may be a blockage in a subsystem, for example, if the unit is a conveying unit or a production unit. The availability of a unit can, if this unit is a person, indicate whether the person is available, for example, or is absent, for example on account of an illness. The operating state of a unit can, if said unit is an apparatus, indicate, by way of example, whether or not the unit is operational, for example because it is undergoing repair or servicing. By way of example, the operating state of equipment used by the respective unit can indicate when an actually available unit, for example a person, is currently incapable of action because a device that is used, for example a delivery vehicle, has become inoperative. The cited examples are not intended to be understood as conclusive but rather merely serve for better understanding.

By way of example, such information pertaining to a unit may be stored as a data record in the respective apparatus that is associated with the unit or in a memory to which the apparatus has access, for example in a memory in a device that also comprises the apparatus. In this case, the stored data records can be updated on a regular basis.

If the feedback comprises general information of this kind pertaining to the current performance capability of further units, then the first apparatus can determine a possible contribution to the service to be provided for each of the units, for example. This can have the advantage that in some cases, it is necessary to determine fewer possible, but more difficult to implement, contributions by some units if easier to implement, corresponding contributions by other units are immediately obtained. For the determination, it is possible for arbitrary rules that are suitable for a respective instance of application to be defined. It is thus possible to pay no attention to units that do not have the requisite total capacity or that are of an unsuitable type, or whose performance speed is out of the question on account of the specifications for the service to be provided. For units that fundamentally do come into consideration, it is then possible to check whether a contribution—for example a distance—can be integrated into an existing action plan for a unit—possibly even with leeway in terms of time—without change, or whether it can be integrated into an existing action plan for a unit with changes if the specifications for already provided contributions to services are taken into consideration.

In one exemplary embodiment, a determination that the service to be provided can be provided at least in part by a unit that has an associated apparatus of the group or by a combination of units that each have an associated apparatus of the group comprises a selection of a contribution by at least one unit that has an associated apparatus of the group to the provision of the service to be provided.

The first apparatus can make a final selection of this kind for a contribution by at least one unit on its own, or can provide at least one alternative for a selection for voting in the group. By way of example, the selection of a contribution by at least one unit can comprise determination of a possible sequence of contributions that results in an optimum overall benefit. The determination of an optimum overall benefit can take into consideration the total path length, the number of transfers required and the utilization level of the units to date, for example. A multiplicity of other or additional criteria can likewise be taken into consideration. If the service to be provided comprises a delivery in a multistory building, then it may make sense for the delivery to be made by a delivery agent who is already scheduled for other deliveries in the building on that day, for example, in order to minimize time-consuming multiple deliveries on high levels.

In one exemplary embodiment, a determination of whether the service can be provided at least in part by a unit that has an associated apparatus of the group or by a combination of units that each have an associated apparatus of the group comprises performance of a vote by the apparatuses of the group about at least one selection, proposed by the first apparatus, of at least one contribution by at least one unit associated with an apparatus of the group to the service to be provided. By way of example, there may thus be provision for a particular proportion of the apparatuses of the group to have to agree to the proposed selection of contributions before the first apparatus can book corresponding capacities.

In one exemplary embodiment, the desired service comprises carriage of at least one piece good. There are also arbitrary other services possible, however, such as manufacture of a product with multiple manufacturing steps or maintenance of an installation.

Exemplary embodiments of the invention can be used for coordinating the performance of services of different type by a group of arbitrary units. It is thus possible for exemplary embodiments of the invention to be used for coordinating the collection and delivery of piece goods by a group of delivery agents. Other exemplary embodiments of the invention can be used for coordinating the distribution of piece goods in a sorting installation. Other exemplary embodiments of the invention can be used for coordinating a variable production process. Other exemplary embodiments of the invention can be used for coordinating maintenance work by a group of agents.

In exemplary embodiments, the first apparatus is a handheld device or a module for a handheld device. By way of example, a handheld device may be a Smartphone, a scanner, a tablet PC or any other electronic device having communication capabilities that can be used by a person for providing a service or a partial service. In another exemplary embodiment, the first apparatus is integrated or integral in a vehicle. In another exemplary embodiment, the first apparatus is part of a sorting installation. In another exemplary embodiment, the first apparatus is part of a production installation. In another exemplary embodiment, the first apparatus is part of an agent responsible for maintenance of a system. If the first apparatus is part of an installation or of an agent, then it may be a piece of control equipment for a unit, or a module for such a piece of control equipment, for example. Such a piece of control equipment may be a computer, for example, and a module for such a piece of control equipment may be a microcontroller, for example. It goes without saying that the other apparatuses of the group may be of corresponding design.

The information received regarding a service to be provided can comprise a request for a desired service or information pertaining to circumstances that adversely affect a previously scheduled flow for the provision of the service, for example. If a delivery agent is in a queue with his delivery vehicle or if his delivery vehicle has a fault, for example, and the provision of one or more already scheduled services is at risk, then the delivery agent can input appropriate information into a handheld device that corresponds to the first apparatus, and the handheld device then coordinates appropriate rescheduling of the already scheduled delivery or deliveries with the handheld devices of other delivery agents of a group.

In one exemplary embodiment, information about the booked capacities is transmitted to a server. Alternatively or additionally, information about a remaining part of the desired service is transmitted to a server, provided that it has been determined that the service can be provided only in part by at least one unit that has an associated apparatus of the group. In one exemplary embodiment, the server can then cause provision of the remaining part of the desired service by at least one unit that has an associated apparatus outside the group of apparatuses.

A first apparatus according to the invention in a group may further be configured to act as a further apparatus of the group with respect to other apparatuses. To this end, a first apparatus according to the invention may be configured to receive from another apparatus of the group a message regarding a service to be provided, to transmit to the other apparatus of the group, on the basis of stored information, feedback about a current performance capability of the unit with which the apparatus is associated and, provided that capacities are booked by the other apparatus, to process the booking.

By way of example, processing of the booking can comprise integration of the contribution into existing scheduled sequences of actions. If the apparatus is associated with a person, then the processing may alternatively or additionally comprise informing the person via a user interface, for example.

By way of example, an apparatus according to the invention can have means in order to communicate with other apparatuses in order to assist other apparatuses in a service-oriented manner and to accept the assistance of other apparatuses. By way of example, an apparatus according to the invention can have means in order to cause a unit with which the apparatus is associated to replace another unit if it has failed. By way of example, an apparatus according to the invention can have means for recognizing whether there is a disruption that can adversely affect an agreed service on the unit with which said apparatus is associated, so that disruptions in the provision of the service can be minimized. By way of example, the disruptions can be recognized on the basis of a user input or a report from a service-providing unit. By way of example, an apparatus according to the invention can have means for recognizing whether there is a disruption in a group, for identifying the disruption and for minimizing the effect of the disruption. By way of example, an apparatus according to the invention can have means in order to undertake resolution, investigation and connection tasks. By way of example, this allows the apparatus itself to detect circumstances that may adversely affect provision of an already booked service to be provided. By way of example, an apparatus according to the invention can have means in order to direct and guide the units with which the apparatuses of the group are associated entirely or in subareas. Generally, by way of example, an apparatus according to the invention can have means in order to move the units of a group for the purpose of providing a service. By way of example, an apparatus according to the invention can have means in order to guide the units with which the apparatuses of a group are associated as a central component of the group and to move said units to render action coherent. By way of example, an apparatus according to the invention can have means in order to assign the adoption of an assigned contribution to a service to be provided—if need be in coordination with other apparatuses of the group—to another unit in the event of a unit failing. By way of example, an apparatus according to the invention can have means in order to schedule the behavior of the unit with which the apparatus itself is associated and to adapt said behavior in accordance with the situation. By way of example, an apparatus according to the invention can have means in order to communicate with the surroundings.

Further advantageous exemplary refinements of the invention can be found in the detailed description below of some exemplary embodiments of the present invention, particularly in conjunction with the figures. The figures are intended to be used only for the purpose of clarification, however, rather than for determining the scope of protection of the invention. The figures are not to scale and are merely intended to reflect the general concept of the present invention by way of example. In particular, features that the figures contain are in no way intended to be deemed an absolutely necessary part of the present invention.

### BRIEF DESCRIPTION OF THE DRAWINGS

In the figures:

FIG. 1 shows a schematic illustration of an exemplary embodiment of a system according to the invention; and

FIG. 2 shows a flowchart having method steps of an exemplary embodiment of the method according to the invention.

### DETAILED DESCRIPTION OF SOME EXEMPLARY EMBODIMENTS OF THE INVENTION

The present invention is described below with reference to exemplary embodiments that allow efficient coordination of provision of a service.

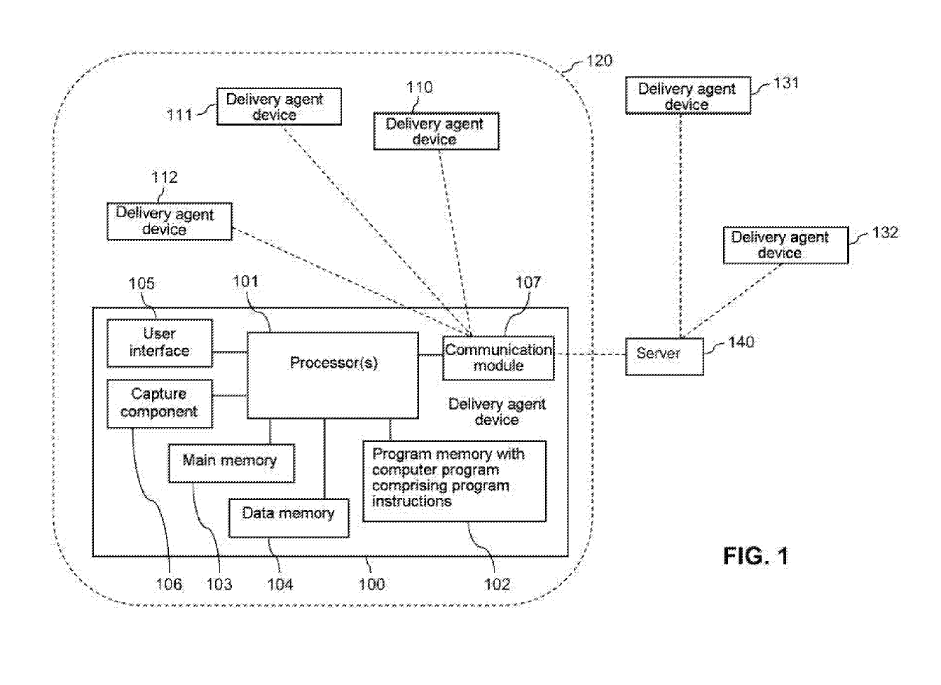

FIG. 1 is a schematic illustration of an exemplary embodiment of a system according to the invention. The system is a system for the carriage of piece goods by delivery agents.

The system comprises a first delivery agent device 100, further delivery agent devices 110, 111, 112, 131 and 132 and a server 140. Delivery agent devices 100, 110, 111 and 112 belong to a defined group 120 of delivery agent devices.

Each of the delivery agent devices 100, 110, 111, 112, 131, 132 is associated with a particular delivery agent. In this case, a delivery agent is not necessarily intended to be understood to mean only a delivery agent who delivers packages to addresses, but rather any person who conveys packages on the path from a sender to a recipient may be meant.

By way of example, the delivery agent device 100 may be a handheld device, for example in the form of a Smartphone or a specific handheld device equipped with a scanner. The delivery agent device 100 comprises a processor 101, a program memory 102, a main memory 103, a data memory 104, a user interface 105, an optical capture component 106 and a communication interface 107.

The processor 101 may be connected to all other components 102-107. The processor 101 is configured to read and execute program instructions from the program memory 102.

The program memory 102 is a nonvolatile memory. The program memory 102 stores computer programs comprising program instructions. The program instructions comprise program instructions for coordinating the provision of services in a group of delivery agent devices and program instructions for cooperating with other delivery agent devices that coordinate the provision of services in a group. The program instructions may be part of a comprehensive piece of delivery agent application software. The program memory 102 can store any other program instructions and also arbitrary parameter values and data.

The main memory 103 is a volatile memory. It is configured to temporarily buffer-store data that are needed by the processor 101.

The data memory 104 is a nonvolatile memory. It is configured to store various data that are needed for deliveries. By way of example, such data can comprise an identification for the delivery agent device 100, an indication of an affiliation of the delivery agent device 100 to a group 120 of delivery agent devices, indications of all other delivery agent devices 110, 111, 112 of the group 120, and also a data record containing information about the current performance capability of a delivery agent with which the delivery agent device 100 is associated. In this case, the information about the current performance capability can relate directly to the delivery agent who is currently using the delivery agent device 100, for example, to a delivery vehicle that the delivery agent is currently using, to packages that the delivery agent needs to convey, to a sequence of actions hitherto envisaged for the day and to external circumstances that adversely affect the work of the delivery agent. Information that relates directly to the delivery agent can comprise an identification for the delivery agent, information pertaining to maximum working hours of the delivery agent, information pertaining to a delivery area of the delivery agent, information pertaining to responsibilities and powers of the delivery agent and/or a current position of the delivery agent, for example. Information that relates to a delivery vehicle of the delivery agent can comprise an identification for the delivery vehicle, information pertaining to the type of the delivery vehicle and/or information pertaining to the state of the delivery vehicle, for example. Information pertaining to the state of the delivery vehicle can involve whether the vehicle is currently operational, what total loading capacity it has, what currently remaining loading capacity there is and/or what capacities are scheduled on what route sections, for example. Information pertaining to a sequence of actions hitherto envisaged can comprise a hitherto scheduled route for the day, for example. In this case, the route may also be linked to indications concerning at what points and/or at what envisaged times and to what extent changes to the free capacity are envisaged, for example. Information pertaining to packages can comprise arbitrary data pertaining to packages that have been loaded, need to be loaded and/or need to be delivered. By way of example, it can indicate a sender, a destination address, volumes and special features such as timing specifications, cash on delivery arrangements or alternative point of delivery, and also information pertaining to the delivery status of individual packages, such as “for collection”, “in the vehicle”, “delivered”, “failed delivery attempt”, etc., for example. Information pertaining to external circumstances can comprise data pertaining to queues or diversions, for example.

The user interface 105 can comprise arbitrary input and output units for the delivery agent, for example a touch sensitive display or a non touch sensitive display, a keyboard, individual keys and/or other operator control elements, a microphone, at least one loudspeaker, etc.

By way of example, the optical capture component 106 may be an integrated barcode scanner or an integrated QR code scanner. If the delivery agent device 100 is a Smartphone, for example, then the optical capture component 106 may instead also be an integrated camera. Suitable program instructions in the program memory 102 may then be provided in order to recognize and provide a code or other information in a recorded image.

By way of example, the communication module 107 may be a mobile radio module that is configured to interchange data with other apparatuses via an arbitrary mobile radio network.

It goes without saying that the delivery agent device 100 can have various other components, such as various sensors, a receiver for a global navigation satellite system, further communication modules, further processors and/or further memories, for example.

The delivery agent device 100 or a component of the delivery agent device 100, which contains at least the processor 101 and the program memory 102, is an exemplary embodiment of an apparatus according to the invention. Such a component could be an integrated circuit, for example.

Further delivery agent devices 110, 111, 112, 131 and 132 may be of similar design to the delivery agent device 100. According to the invention, they may be the further apparatuses, while the delivery agents may be exemplary units that each have an associated apparatus.

The affiliation of the delivery agent devices 100, 110, 111, 112 to the group 120 may be firm or variable. As such, a new group 120 could be defined each day, for example. By way of example, the group 120 can comprise all delivery agent devices that are associated with delivery agents who work in a particular city or in a particular delivery area of a city.

The delivery agent devices 131 and 132 may optionally belong to another group. Some delivery agent devices may even not be associated with a group, for example because they are associated with delivery agents who transport packages over long distances. In an alternative embodiment, all delivery agent devices could also belong to a single group.

The server 140 is a fixed server in a logistics company. By way of example, it is connected to the internet via a local area network and can interchange data with all delivery agent devices 100, 110, 111, 112, 131 and 132 via said local area network and further via the mobile radio network.

The connections shown or described between components are intended to be understood as functional connections. They can be implemented directly or indirectly via multiple other components.

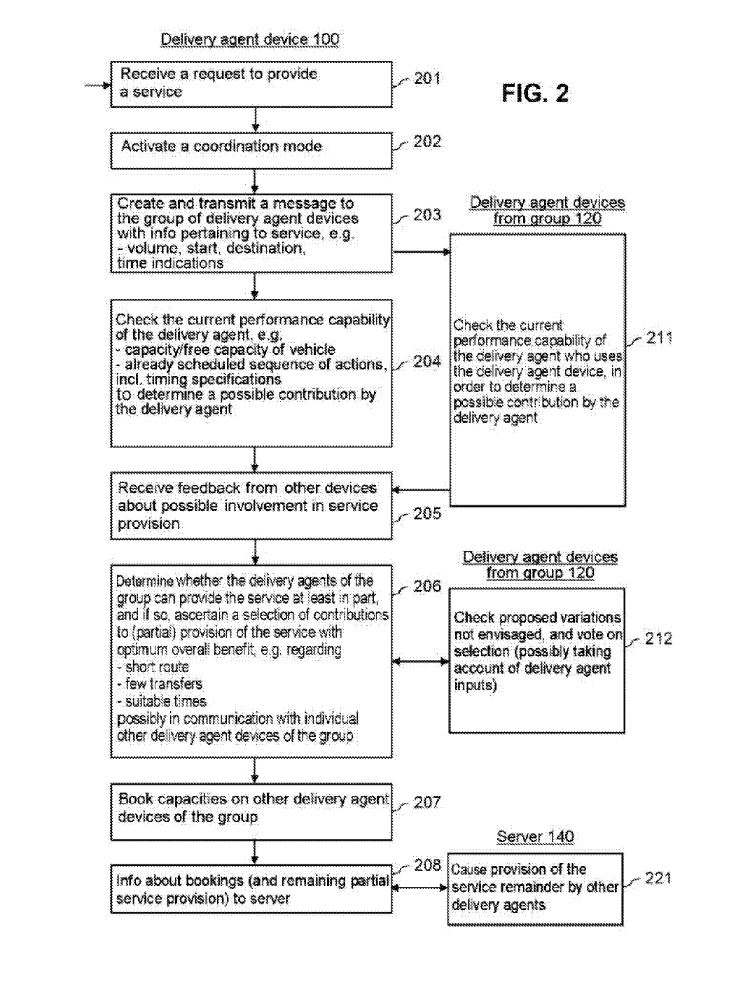

FIG. 2 is a flowchart that illustrates an exemplary embodiment of a method according to the invention, performed in the system from FIG. 1.

The actions shown on the left-hand side are in this case performed by the delivery agent device 100 when the processor 101 reads and executes corresponding program instructions from the program memory 102 and hence causes the delivery agent device 100 to perform the actions. Actions shown on the right-hand side are performed by other delivery agent devices 110, 111, 112 from the group 120, or by server 140.

By way of example, the delivery agent with which the delivery agent device 100 is associated learns, during communication with a large customer, that the latter has a need to collect packages within the limits of a swap container. The delivery agent inputs corresponding indications via the user interface 105 of the delivery agent device 100. By way of example, the indications can contain a service identification, a collection address, a delivery address, a desired collection time, a desired delivery time and/or a desired lead time, a volume of the delivery and a service priority. If a customer has already booked a service on line and printed a corresponding receipt, then the indications can also be captured by scanning a code on the receipt by means of the optical capture component.

The delivery agent device 100 receives the indications and interprets them as a request for provision of a service. The received request is information received regarding a service to be provided, for example.

The delivery agent device 100 then automatically activates a coordination mode. In coordination mode, the delivery agent device 100 is responsible for scheduling—as far as fully or partially possible—provision of the service by the group 120. Activation of the coordination module can involve appropriate program instructions being called.

In coordination mode, the delivery agent device 100 automatically creates a message regarding the desired service on the basis of the received information. By way of example, the message can take on the received indications completely. Furthermore, the delivery agent device 100 automatically transmits the message to all other delivery agent devices of the group 120 to which the delivery agent device 100 belongs. The information pertaining to the other delivery agent devices of the group 120 that is needed for the transmission is read from the data memory 104. The transmission is effected by mobile radio using the communication module 107.

The delivery agent device 100 checks the current performance capability of the delivery agent with which the delivery agent device 100 is associated, on the basis of indications that are currently stored in a corresponding data record in the data memory 104. On the basis of the determined current performance capability of the delivery agent and the received information for the service to be provided, the delivery agent device 100 determines whether the delivery agent can make a contribution to carriage of the packages. The evaluation is made on the basis of predefined rules that are part of the program instructions. The rules can be embodied arbitrarily in this case. By way of example, it is possible for the general capacity or for a type of the delivery vehicle to be taken as a basis for determining whether the delivery agent is in principle capable of carrying the stated volume. On the basis of a coarse route between starting point and destination for the new delivery, it would then be possible to determine, by way of example, whether the sequence of actions hitherto envisaged for the delivery agent envisages a similar route, at least in sections, whether sufficient free capacities can be expected on this section and whether the correlation matches the time schedule envisaged for the new delivery. In this case, sections could begin or end preferably at the starting point, at the destination and at bases in the system, at which simple transfer of packages between different delivery agents can be scheduled.

In parallel with this, each of the other delivery agent devices 110, 111, 112 of the group 120 receives the message transmitted in action 203, by mobile radio. It checks the current performance capability of the delivery agent who uses the respective delivery agent device 110, 111, 112, and takes this current performance capability and the information received pertaining to the service to be provided as a basis for determining whether the delivery agent can make a contribution to carriage of the packages. Determination can be effected in the same manner as in the delivery agent device 100. Information about a possible contribution is transmitted to the delivery agent device 100 by mobile radio. The information can comprise a specific, preferred contribution and acceptable deviations, for example.

The delivery agent device 100 receives the feedback from the other delivery agent devices 110, 111, 112 about the possible contribution that they can make.

The delivery agent device 100 then takes its own possible contribution and the possible contributions of the other delivery agent devices of the group 120 as a basis for determining whether the delivery agents of the group 120 can provide the service fully or in part. If this is the case, then the delivery agent device 100 determines a selection of contributions to complete or partial provision of the service by the delivery agents of the group 120 with optimum overall benefit. By way of example, the optimum overall benefit can take into consideration the length of the overall route, the number of transfers required, compliance with predetermined times and arbitrary further factors. For this purpose, the delivery agent device 100 has control processes available as part of the program instructions, said control processes mapping a benefit function and hence allowing value formation. If need be, the delivery agent device 100 can clarify with individual other delivery agent devices of the group 120, within the context of selection of contributions to providing the requested service, whether a provided contribution can be varied to a greater extent than indicated. By way of example, the delivery agent device 100 can clarify whether leaving an associated delivery area, a greater variation in timing for a contribution provided or an extension of the regular working hours for a delivery agent of the group 120 is a possibility, etc.

The delivery agent devices 110, 111, 112 receiving an enquiry check the variations possibly proposed by the delivery agent device 100. To this end, the delivery agent device 110, 111, 112 can, if required, also request an input from the delivery agent with which it is associated. The delivery agent devices 110, 111, 112 receiving an enquiry deliver feedback with the result to the delivery agent device 100.

The feedback can then be additionally taken into consideration by the delivery agent device 100 in action 206.

In addition or as an alternative to collection of consent pertaining to variations in the reported possible contributions, the delivery agent device 100 can, prior to the final selection of contributions to the requested service, optionally propose to all or selected delivery agent devices 110, 111, 112 of the group 120 at least one advantageous selection of contributions to providing the requested service, about which it is then possible to vote in the group 120. Various specifications may be provided for the vote. By way of example, it may be necessary for all delivery agent devices of the group 120 or a fixed proportion of said delivery agent devices to consent to a particular selection of contributions, or else for all delivery agent devices of the group 120 that are envisaged for a selection of contributions or a fixed proportion of said delivery agent devices to consent. A consent may optionally also be dependent on a confirmation from the respective delivery agent. It goes without saying that a selection of contributions can also comprise a single contribution.

If a selection of contributions has been determined and, if need be, confirmed in a vote, then the delivery agent device 100 books the capacities required therefor on the relevant delivery agent devices of the group 120. If the delivery agent with which the delivery agent device 100 is associated undertakes part of the service, then an internal booking is also made. The booking on the other delivery agent devices of the group 120 is again made by means of an appropriate message that is transmitted to the relevant other delivery agent devices of the group 120 by means of mobile radio. The delivery agent devices of the group 120 on which capacity has been booked inform their delivery agent via the user interface of the respective delivery agent device.

The vote between the delivery agent devices 100 thus takes place on a local basis, i.e. the indications from the individual delivery agent devices are not first of all collected and evaluated by a server.

Additionally, the delivery agent device 100 can inform the server 140 about the order, the bookings and if need be about a remaining part of the service to be provided that cannot be provided by the group 120, however. The delivery agent device 100 can then leave the coordination mode again.

If there is a remainder of the service to be provided, then the server 140 causes provision of this service remainder by other delivery agents outside the group 120. The server 140 can in this case schedule precise assignment of the service remainder itself, or it merely picks a suitable further group and tasks a delivery agent device in this further group with coordinating provision of the service remainder. This delivery agent device can then proceed in a similar manner to the delivery agent device 100 in actions 201 to 208. By way of example, the further group can contain all delivery agent devices 131, 132 that do not belong to the group 120, or else just some of these delivery agent devices.

Similarly, it is also possible to handle a disruption that affects already scheduled services. If the delivery vehicle of a delivery agent has a fault, for example, then the delivery agent can input corresponding information into his delivery agent device. This information is recognized as information regarding each service to be provided to which the delivery agent should make a contribution. The delivery agent device can then independently reschedule provision of the services in communication with the other delivery agent devices of the group. A large part of the information pertaining to the services can in this case be retrieved by the delivery agent device from its data memory. For all packages already loaded, a new starting point corresponds to the current whereabouts of the delivery agent in this case, and the desired new collection time corresponds to the current time. The services to be rescheduled can be rescheduled individually, for example.

Particular embodiments of the invention thus have provision for, instead of carriage of packages being coordinated by means of a server in a controlling manner, carriage of packages being coordinated in a regulatory manner, this being able to be performed autonomously, adaptively and in self-learning fashion by a group of delivery agent devices. In this case, a respective one of the delivery agent devices acts as a central, guiding component of the group, particularly the delivery agent device on which new information pertaining to a service to be provided is received; all or multiple instances of the delivery agent devices of a group may be configured to adopt such a guiding role. The respective other delivery agent devices of the group are also not pure receivers of bookings, however, but rather evaluate the current state itself and provide feedback. Since it is not just a respective delivery agent device that acts in optimum fashion from its point of view but also the group that acts in optimum fashion from the point of view of the group, it is possible for services to be performed more economically, since lead times can be reduced, for example. It is furthermore possible for the services to be performed to the greater satisfaction of the customers, since appointments connected to the services can be kept particularly well, for example.

Blocks 201-208 in FIG. 2 can also be regarded as a representation of corresponding program instructions in program memory 102.

The system shown by way of example in FIG. 1 can be modified in a wide variety of ways within the framework of the invention, both by adding components and by omitting components, and also by modifying components. This can result in further or alternative advantages in each case. Modifications can also be made for adaptation to suit totally different fields of use.

The method described by way of example with reference to FIG. 2 can likewise be modified in a wide variety of ways within the framework of the invention, by adding actions, by omitting actions and by modifying actions. This can likewise result in further or alternative advantages in each case. The sequence of actions outlined in the flowchart in FIG. 2 is also not imperative; alternative sequences are conceivable. Finally, the actions can be implemented in different ways. Modifications can in turn also be made for adaptation to suit totally different fields of use.

By way of example, instead of a possible contribution by a delivery agent, the other delivery agent devices of the group 120 can also transmit to the first delivery agent device 100, in action 211, predetermined data, which have not been processed further, pertaining to the current performance capability of the delivery agent. The first delivery agent device 100 could then first of all determine possible contributions by all other delivery agent devices of the group 120 in action 206.

By way of example, all delivery agent devices in the system could belong to a single group.

By way of example, the invention could also be implemented in a sorting installation, with a plurality of units, for example conveyor belts, filters and/or sorters, ensuring that piece goods are carried along a respectively provided route. In this case, the apparatuses of a group could be fixed coordination apparatuses, for example in the form of a microcomputer having the communication interface. Each coordination apparatus could be associated with a sorting unit or with a conveying unit and could control said unit. A respective one of the coordination apparatuses could then receive information about a sorting service to be provided, for example from a sensor that optically captures indications on a piece good. By way of example, the information could contain an indication of a destination for the piece good and an indication of a desired type of carriage and hence implicitly also about a suitable output location in the sorting installation. The coordination apparatus that receives the information could be associated with a sorting or conveying unit that is arranged directly following the location of capture by the sensor. This coordination apparatus then coordinates provision of the service with all other coordination apparatuses in accordance with their current performance capability in order to provide the requisite sorting service usefully and in as efficient a manner as possible. By way of example, the coordinated service provision can predetermine the route and an advantageous speed on each route section so that collisions with other carried operations are avoided.

By way of example, the invention could also be implemented for maintenance of a system. A maintenance event requires spare parts and assembly activity. It is conceivable for an agent 1 to perform assembly operations on operational facilities and for another agent 2 e.g. to use a 3D printer to produce and provide the spare parts “on demand”. The agents are not necessarily human beings. Rather, this approach is suitable for complete automation of activities that are today still predominantly performed by human beings. The agents in this system are robots or technical automatic machines, for example. The service on the agents can be defined as follows, for example:
a) agent 1 is used to pursue the service of maximizing the number of undisrupted working hours for operating technology. It therefore pursues the strategy of increasing availability by removing disruption, as through repair, and of keeping it at a particular level.
b) agent 2 pursues the service of being able to produce simple mechanical components independently and reducing the necessary classical warehousing requirement. Further, this agent can mix materials according to need in order to define the fatigue strength of these simple mechanical components.

By way of example, a scenario as follows would then be conceivable: agent 1 carries out a repair and removes a damaged part. He checks this damaged part and comes to the conclusion that he needs an identical part of greater robustness. He then communicates with agent 2 and requests this service at the repair location. From communication with neighboring agents, agents 1 and 2 then establish that the reliability of the operational facility needs to be increased further. They develop a joint strategy for plant optimization by virtue of agent 1 first of all dispensing with further repair in favor of a more critical process and removing disruption at another point. Agent 2 provides his service directly at the more critical point and thus optimizes the warehouse availability of the spare part locally. After the more critical process has concluded, agents 1 and 2 go to the point of repair and continue their original instruction. In this case, the optimization task is geared e.g. to a system availability of a customer system, which itself could also be an agent.

In this example, the invention could take effect in multiple situations. As such, the agents 1 and 2 and also the neighboring agents could be units according to the invention that each comprise an apparatus according to the invention. The apparatuses and hence also the agents could belong to a group. First of all, the apparatus of agent 1 could establish in the course of maintenance work that there is a need for a service that cannot be provided by agent 1 alone, for example replacement of a part with a spare part. By way of example, agent 1 could be capable of replacing the part, but might not have it available. The apparatus of agent 1 could then send a message concerning the required service to the apparatuses of the other agents of the group and determine, from rule-based evaluation of the feedback, that the service can be provided jointly with agent 2, since the latter is capable of providing a spare part. The apparatus of agent 1 could then book appropriate capacities on itself and on agent 2. Agent 1 and agent 2 could then tackle provision of the service together. Furthermore, the apparatuses of agents 1 and 2 could, during provision of the service, receive a message from a neighboring agent that points out a further, urgently required service. The apparatuses of agents 1 and 2 could establish that the maintenance measure currently being performed is less urgent than the further service. They could determine what contribution they can make to the urgently required service and could send appropriate feedback to the apparatus of the requesting neighboring agent. If the requesting neighboring agent then books appropriate capacities on agent 1 and/or agent 2, agent 1 and agent 2 could leave the current service provision in order to assist in the more urgent service provision first of all and then to complete the current service provision.

Similarly, the invention can be used for many other situations that require technical collaboration in order to provide a service.

It goes without saying that the embodiments described are generally merely examples that can be modified and/or augmented in a wide variety of ways within the framework of the claims. In particular, any feature that has been described for a particular exemplary embodiment can be used independently or in combination with other features in any other exemplary embodiment. Any feature that has been described for an exemplary embodiment in a particular category can also be used in corresponding fashion in an exemplary embodiment in a different category.

What is claimed is:

1. A method performed by a first apparatus of a group of apparatuses, wherein each apparatus of the group is associated with a particular unit, the method comprising:
receiving information regarding a service to be provided,
transmitting a message to a plurality of other apparatuses of the group regarding the service to be provided, on the basis of the received information,
determining, on the basis of rules, whether the service to be provided can be provided at least in part by a unit that has an associated apparatus of the group or by a combination of units that each have an associated apparatus of the group on the basis of the information regarding the service to be provided, on the basis of stored information pertaining to the current performance capability of a first unit with which the first apparatus is associated, and on the basis of feedback from other apparatuses of the group pertaining to the current performance capability of other units with which the apparatuses that provide the feedback are associated, and
if it is determined that the service can be provided at least in part by a unit that has an associated apparatus of the group or by a combination of units that each have an associated apparatus of the group, booking capacities on the at least one apparatus of the group that is associated with the at least one unit that can provide the service at least in part.

2. The method according to claim 1, wherein a unit that has an associated apparatus of the group,
is a person optionally using a vehicle or
is a component of a sorting installation or
is a component of a production installation or
is an agent responsible for maintaining a system.

3. The method according to claim 1, wherein the feedback from other apparatuses of the group pertaining to the current performance capability of units with which the apparatuses that provide the feedback are associated comprises an indication of a possible contribution by the units to the provision of the service to be provided.

4. The method according to claim 1, wherein the information pertaining to the current performance capability of the first unit and/or the feedback pertaining to the current performance capability of further units comprises information pertaining to:
a predetermined responsibility of the respective unit and/or
a total capacity of the respective unit and/or
a type of the respective unit and/or
a type of equipment used by the respective unit and/or
a possible performance speed of the respective unit and/or
a free capacity of the respective unit and/or
services to be performed that are already scheduled for the respective unit and/or
specifications for already scheduled services to be performed by the respective unit and/or
a status of services to be performed by the respective unit and/or
a current position of the respective unit and/or
current obstacles that affect the respective unit and/or
an availability of the respective unit and/or
an operating state of the respective unit and/or
an operating state of equipment used by the respective unit.

5. The method according to claim 1, wherein a determination that the service can be provided at least in part by a unit that has an associated apparatus of the group or by a combination of units that each have an associated apparatus of the group comprises a selection of a contribution by at least one unit that has an associated apparatus of the group to the provision of the service to be provided.

6. The method according to claim 1, wherein the determination comprises performance of a vote by the apparatuses of the group about at least one selection, proposed by the first apparatus, of at least one contribution by at least one unit associated with an apparatus of the group to the service to be provided.

7. The method according to claim 1, wherein the service to be provided comprises carriage of at least one piece good.

8. The method according to claim 1, wherein the first apparatus
is a handheld device or
is a module for a handheld device or
is integrated in a vehicle or
is part of a sorting installation or
is part of an agent responsible for maintaining a system or
is a piece of control equipment or
is a module for a piece of control equipment.

9. The method according to claim 1, wherein the received information regarding a service to be provided comprises
a request for a desired service or
information pertaining to circumstances that adversely affect a previously scheduled flow for the provision of the service.

10. The method according to claim 1, further comprising:
transmitting information about the booked capacities to a server and/or
transmitting information about a remaining part of the service to be provided to a server, provided that it has been determined that the service can be provided only in part by at least one unit that has an associated apparatus of the group, and/or
transmitting information about a remaining part of the service to be provided to a server, provided that it has been determined that the service can be provided only in part by at least one unit that has an associated apparatus of the group, wherein the server causes the provision of the remaining part of the service to be provided by at least one unit that has an associated apparatus outside the group.

11. An apparatus comprising at least one memory having program instructions and at least one processor, the program instructions configured to, when executed by the at least one processor, cause the apparatus to perform the following:
receive information regarding a service to be provided,
transmit a message to a plurality of other apparatuses of the group regarding the service to be provided, on the basis of the received information,
determine, on the basis of rules, whether the service to be provided can be provided at least in part by a unit that has an associated apparatus of the group or by a combination of units that each have an associated apparatus of the group on the basis of the information regarding the service to be provided, on the basis of stored information pertaining to the current performance capability of a first unit with which the first apparatus is associated, and on the basis of feedback from other apparatuses of the group pertaining to the current performance capability of other units with which the apparatuses that provide the feedback are associated, and
if it is determined that the service can be provided at least in part by a unit that has an associated apparatus of the group or by a combination of units that each have an associated apparatus of the group, book capacities on the at least one apparatus of the group that is associated with the at least one unit that can provide the service at least in part.

12. The apparatus according to claim 11, wherein a unit that has an associated apparatus of the group,
is a person optionally using a vehicle or
is a component of a sorting installation or
is a component of a production installation or
is an agent responsible for maintaining a system.

13. The apparatus according to claim 11, wherein the feedback from other apparatuses of the group pertaining to the current performance capability of units with which the apparatuses that provide the feedback are associated comprises an indication of a possible contribution by the units to the provision of the service to be provided.

14. The apparatus according to claim 11, wherein the information pertaining to the current performance capability of the first unit and/or the feedback pertaining to the current performance capability of further units comprises information pertaining to:
a predetermined responsibility of the respective unit and/or
a total capacity of the respective unit and/or
a type of the respective unit and/or
a type of equipment used by the respective unit and/or
a possible performance speed of the respective unit and/or
a free capacity of the respective unit and/or
services to be performed that are already scheduled for the respective unit and/or
specifications for already scheduled services to be performed by the respective unit and/or
a status of services to be performed by the respective unit and/or
a current position of the respective unit and/or
current obstacles that affect the respective unit and/or
an availability of the respective unit and/or
an operating state of the respective unit and/or
an operating state of equipment used by the respective unit.

15. The apparatus according to claim 11, wherein a determination that the service can be provided at least in part by a unit that has an associated apparatus of the group or by a combination of units that each have an associated apparatus of the group comprises a selection of a contribution by at least one unit that has an associated apparatus of the group to the provision of the service to be provided.

16. The apparatus according to claim 11, wherein the determination comprises performance of a vote by the apparatuses of the group about at least one selection, proposed by the first apparatus, of at least one contribution by at least one unit associated with an apparatus of the group to the service to be provided.

17. The apparatus according to claim 11, wherein the service to be provided comprises carriage of at least one piece good.

18. The apparatus according to claim 11, wherein the received information regarding a service to be provided comprises
a request for a desired service or
information pertaining to circumstances that adversely affect a previously scheduled flow for the provision of the service.

19. The apparatus according to claim 11, wherein the program instructions are further configured to, when executed by the at least one processor, cause the apparatus to perform the following:
transmit information about the booked capacities to a server and/or
transmit information about a remaining part of the service to be provided to a server, provided that it has been determined that the service can be provided only in part by at least one unit that has an associated apparatus of the group, and/or
transmit information about a remaining part of the service to be provided to a server, provided that it has been determined that the service can be provided only in part by at least one unit that has an associated apparatus of the group, wherein the server causes the provision of the remaining part of the service to be provided by at least one unit that has an associated apparatus outside the group.

20. The apparatus according to claim 11, wherein the program instructions are further configured to, when executed by the at least one processor, cause the apparatus to perform the following:
receive from another apparatus of the group a message regarding a service to be provided,
transmit to the other apparatus of the group, on the basis of stored information, feedback about a current performance capability of the unit with which the apparatus is associated, and
provided that capacities are booked by the other apparatus, process the booking.

21. The apparatus according to claim 11, wherein the first apparatus
is a handheld device or
is a module for a handheld device or
is integrated in a vehicle or
is part of a sorting installation or
is part of an agent responsible for maintaining a system or
is a piece of control equipment or
is a module for a piece of control equipment.

22. A non-transitory computer readable medium storing a computer program having program instructions that are configured to cause an apparatus to perform the following when they are executed by at least one processor:
receive information regarding a service to be provided,
transmit a message to a plurality of other apparatuses of the group regarding the service to be provided, on the basis of the received information,
determine, on the basis of rules, whether the service to be provided can be provided at least in part by a unit that has an associated apparatus of the group or by a combination of units that each have an associated apparatus of the group on the basis of the information regarding the service to be provided, on the basis of stored information pertaining to the current performance capability of a first unit with which the first apparatus is associated, and on the basis of feedback from other apparatuses of the group pertaining to the current performance capability of other units with which the apparatuses that provide the feedback are associated, and
if it is determined that the service can be provided at least in part by a unit that has an associated apparatus of the group or by a combination of units that each have an associated apparatus of the group, book capacities on the at least one apparatus of the group that is associated with the at least one unit that can provide the service at least in part.
